(19) United States
(12) Patent Application Publication
(10) Pub. No.: US 2024/0338462 A1
(43) Pub. Date: Oct. 10, 2024

(54) SYSTEMS AND METHODS FOR DATA ACCESS GENERATION

(71) Applicant: OneSky Flight LLC, Richmond Heights, OH (US)

(72) Inventor: Benjamin Maddox, Richmond Heights, OH (US)

(73) Assignee: OneSky Flight LLC, Richmond Heights, OH (US)

(21) Appl. No.: 18/582,870

(22) Filed: Feb. 21, 2024

Related U.S. Application Data
(60) Provisional application No. 63/494,687, filed on Apr. 6, 2023.

(51) Int. Cl. G06F 21/60; G06F 16/23; G06F 16/242

(52) U.S. Cl. CPC G06F 21/604; G06F 16/2358; G06F 16/2443; G06F 2221/2141

(57) ABSTRACT

Embodiments described herein are related to a computer-implemented method including receiving, by a processor, a request for a data access file, retrieving a data record from a database based on a stored procedure associated with the database, generating, by the processor, the data access file based on the stored procedure and the retrieved data, wherein the data access file comprises a mapping between a first property in an application associated with the database and a second property of the data record, and wherein the data access file comprises instructions for invoking the stored procedure to query the database for the data record, and translating a first request for the data record in the database into a second request for the data record in the database using the data access file, wherein the second request uses the stored procedure to access the data record in the database.

### CROSS-REFERENCE TO RELATED APPLICATIONS

This application claims priority to U.S. Provisional Application No. 63/494,687, filed Apr. 6, 2023, which is incorporated by reference in its entirety.

### TECHNICAL FIELD

This application relates generally to offering upgrades for transportation services to conserve transportation resources.

### BACKGROUND

Tiered applications and computing systems leverage different tiers such as a presentation tier, an application tier, and a data tier in order to independently create, manage, and scale individual tiers. Communication between tiers requires communication protocols which are compatible with the structures, data formats, and properties of the tiers between which communication takes place. For example, communication between an application tier and a data tier requires a communication protocol which is compatible with formats and programming languages of the application tier and the data tier.

### SUMMARY

Conventional systems and methods for facilitating communication between different tiers or layers of an application require significant customization to ensure compatibility between the tiers or layers of the application. Some conventional systems and methods require developers to hand-code data-tier code for a data tier to access data from a database, application-tier code for an application layer to request the data from the data tier, and a mapping between the data-tier code and the application-tier code. Other conventional systems and methods dynamically generate data-tier code based on application-tier code, but this does not allow developers to modify the data-tier code to address performance or optimization issues.

Embodiments discussed herein may address shortcomings in the art and provide additional or alternative improvements or benefits. The embodiments discussed herein provide for automatic generation of data access files configured to facilitate access to data in a database. Automatic generation of the data access files represents a technical improvement over conventional systems and methods for facilitating communication between different tiers or layers of an application. Automatic generation of data access files allows for customization of the procedures in the data access files for accessing the data in the database, allowing for resolution of performance issues and optimization of data access procedures. In this way, the automatic generation of data files may improve the functioning of a computer by allowing for improvement of application performance regarding data access and improvement of data access procedures. Automatic generation of the data access files also preserves data access permissions, maintaining security of the database. The data access files may serve as a buffer between application code and database code, preventing a weakness or exploitation of application code from compromising the data in the database. Furthermore, automatic generation of the data access files reduces errors in generating the data access files, improving performance of the data access files and a data tier which uses the data access files to facilitate access to data in the database.

Aspects of the present disclosure are directed to a computer-implemented method including receiving, by a processor, a request for a data access file indicating a stored procedure for accessing a database; identifying, by the processor, a data record in the database using the stored procedure, the stored procedure comprising executable instructions for accessing the data record in the database; generating, by the processor, the data access file based on the stored procedure and the retrieved data record, the data access file including a mapping between a first property in an application associated with the database and a second property of the data record in the database, and the data access file further including instructions for invoking the stored procedure to query the database for the data record; and in response to receiving a first request for the data record in the database, translating, by the processor, the first request for the data record into a second request for the data record according to the mapping in the data access file, wherein the second request uses the stored procedure invoked by the data access file to access the data record in the database.

The computer-implemented method may include, in response to an update to the stored procedure, retrieving, by the processor, a second data record from the database based on the updated stored procedure, generating, by the processor, an updated data access file based on the updated stored procedure and the second data record, and translating a third request for the data in the database into a fourth request for the data in the database using the updated data access file, wherein the fourth request uses the updated stored procedure to access the second data record in the database. The computer-implemented method may include receiving, by the processor, an indication of the update to the stored procedure from the database. The computer-implemented method may include periodically polling the database for the update to the stored procedure. In the computer-implemented method, the update to the stored procedure may be made by an administrator computer. In the computer-implemented method, the stored procedure may be configured to return data from one or more tables of the database based on one or more input parameters. In the computer-implemented method, the first request may include an application programming interface (API) call. In the computer-implemented method of claim 1, the second request may use a calling code of the data access file to call the stored procedure. In the computer-implemented method of claim 1, the first request may include a database operation and an identifier of the database. In the computer-implemented method, the data access file may include a mapping between the database operation and the stored procedure.

Aspects of the present disclosure are directed to a system including a database including a non-transitory machine-readable storage medium configured to store a plurality of data records and query the plurality of data records according to one or more stored procedures, and a server including a processor, configured to in response to receiving a request for a data access file indicating a stored procedure for accessing a database, retrieve a data record from the database based on the stored procedure containing instructions for accessing the data record in the database; generate the data access file based on the stored procedure and the retrieved data record, the data access file including a mapping between a first property in an application associated with the database and a second property of the data record in the database, and the data access file further including instructions for invoking the stored procedure to query the database for the data record; and in response to receiving a first request for the data record in the database, translate the first request for the data record into a second request for the data record according to the mapping in the data access file, wherein the second request uses the stored procedure invoked by the data access file to access the data record in the database.

The server may be further configured to, in response to an update to the stored procedure, retrieve a second data record from the database based on the updated stored procedure, generate an updated data access file based on the updated stored procedure and the second data record, and translate a third request for the data in the database into a fourth request for the second data record in the database using the updated data access file, wherein the fourth request uses the updated stored procedure to access the second data record in the database. The server may be further configured to receive an indication of the update to the stored procedure from the database. The server may be further configured to periodically poll the database for the update to the stored procedure. The server may be further configured to receive the update to the stored procedure from an administrator computer. The server may be configured to return data from one or more tables of the database based on one or more input parameters. The first request may include an application programming interface (API) call. The second request may use a calling code of the data access file to call the stored procedure. The first request may include a procedure and an identifier of the database. The data access file may include a mapping between the procedure and the stored procedure.

It may be to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification, illustrate an embodiment of the invention, and, together with the specification, explain the invention.

FIG. 1 illustrates components of computer system, according to an embodiment.

FIG. 2 illustrates components of a computer system, according to an embodiment.

FIG. 3 is an example flow chart illustrating operations of a method for generating data access files, according to an embodiment.

FIG. 4 is an example flow chart illustrating operations of a method for generating updated data access files, according to an embodiment.

FIG. 5 is an example flow chart illustrating operations of a method for generating data access files, according to an embodiment.

### DETAILED DESCRIPTION

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

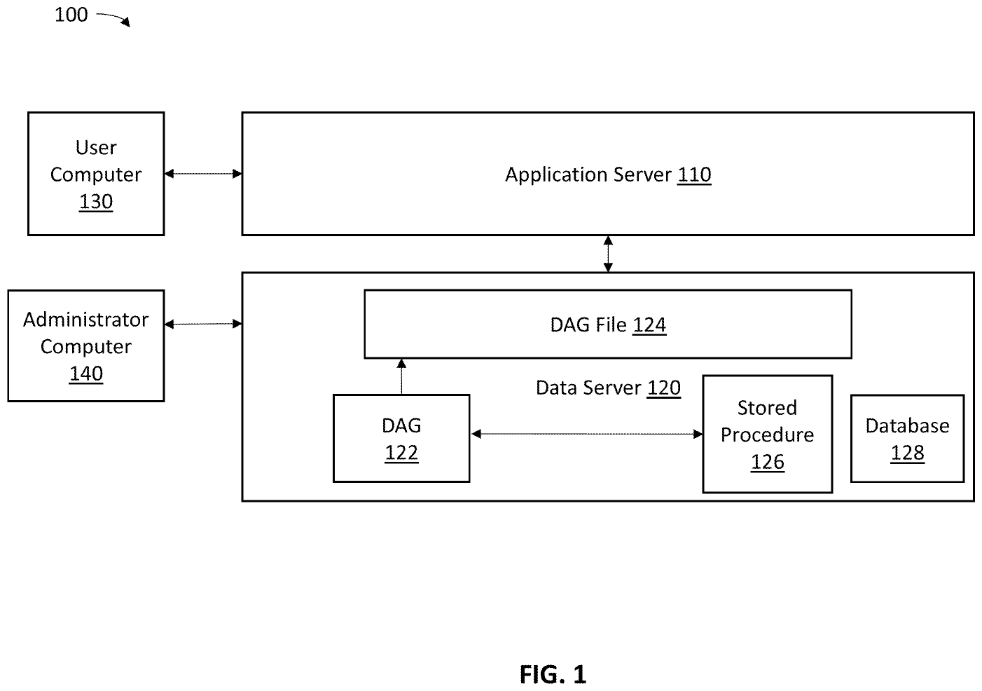

FIG. 1 illustrates an example computer system 100, in accordance with some embodiments of the present disclosure. The computer system 100 includes an application server 110, a data server 120, a user computer 130, and an administrator computer 140.

The application server 110 may include one or more processors and one or more non-transitory, computer readable mediums including instructions which may be executed by the one or more processors to perform processes as discussed herein. The data server 120 may include one or more processors and one or more non-transitory, computer readable mediums including instructions which may be executed by the one or more processors to perform methods and processes as discussed herein.

The application server 110 may be an application tier of an application and the data server 120 may be a data tier of the application. The application server 110 may store instructions in memory and execute the instructions to host an application. A user computer 130 may communicate with the application server 110 to use the application. The application server 110 may deliver the application to the user computer 130 for display on the user computer 130. In some implementations, the application server 110 may stream a user interface to the user computer 130. The application server 110 may communicate with the data server 120 to access data related to the application. For example, the application server 110 may receive, via the user interface of the application, from the user computer 130, a request to display application data at the user interface. The application server 110 may retrieve data from the data server 120 based on the request and display the retrieved data at the user interface of the application.

The application server 110 receives data from the data server 120 in response to a request for data. The request may be an application programming interface (API) call. The data server 120 may retrieve data from a database 128 in response to the request. The database 128 may include data associated with the application. The application server 110 may transmit to the data server 120 requests to receive data, to modify data, to delete data and/or to add data to the database 128. The application server 110 may transmit the requests in response to input from the user computer 130 at the user interface. The data server 120 may perform one or more actions to retrieve, modify, delete, and/or add data in the database 128 based on the requests from the application server 110. In an example, the application server 110 receives a request from the user computer 130 to update maintenance information of an aircraft in the application. The application server 110 transmits a request to the data server 120 to update the maintenance information in the database 128. In response to the request from the application server 110, the data server 120 updates the maintenance data in the database 128. The request from the application server 110 may include a database operation and an identifier of the database 128.

The data server 120 includes a stored procedure 126. The stored procedure 126 may define a process for accessing data in the database 128. The stored procedure 126 may be a named procedure which can be called by the data server 120 for accessing data in the database 128. The stored procedure 126 may accept parameters and return results from a database table or a view of the database 128. In an example, the data server 120 calls the stored procedure 126 by a name of the stored procedure using an aircraft identifier as an input parameter to retrieve data associated with the aircraft identifier from the database 128. In some implementations, the stored procedure 126 may return data from the database 128 without input parameters. In an example, the data server 120 calls the stored procedure by name to determine a size of the database 128. The stored procedure 126 may modify, delete, or add data to the database 128. In some implementations, the stored procedure 126 is an SQL code and/or set of SQL statements and the database 128 is an SQL database. In some implementations, the stored procedure 126 is stored in a JavaScript Object Notation (JSON) object.

The stored procedure 126 may be stored on the database 128. The stored procedure 126 may be stored on the data server 120 separate from the database 128. The data server 120 and/or the database 128 may include a plurality of stored procedures. Different stored procedures of the plurality of stored procedures may be called for accessing or modifying different types of data in the database 128. Different stored procedures may be called for performing different operations on data in the database 128. The plurality of stored procedures may define an interface for accessing and/or modifying data in the database 128. In some implementations, the plurality of stored procedures are stored in a JSON object. The JSON object may be a settings file stored in the database 128. In some implementations, the settings file may be stored in the data server 120 separate from the database 128. The data server 120 may include a plurality of databases. The settings file may include stored procedures for the plurality of databases. The settings file may include a second for each database of the plurality of databases.

The data server may include a data access generator (DAG) 122. In some implementations, the DAG 122 may be on the administrator computer 140 or on another computing device. In some implementations, the DAG 122 may be executable software. The DAG 122 may generate a DAG file 124 based on the stored procedure 126 and/or data in the database 128. The DAG 122 may generate the DAG file 124 to facilitate communication between the application server 110 and the data server 120. The DAG 122 may include a mapping between a property in the application and a property in the database 128. The DAG 122 may execute the stored procedure 126 to determine what inputs the stored procedure 126 requires. The DAG 122 may generate the DAG file 124 based on the stored procedure 126 and the inputs required by the stored procedure 126. The DAG 122 may call the stored procedure 126 to retrieve data from the database 128. The DAG 122 may modify the DAG file 124 based on the retrieved data. The DAG 122 may modify the DAG file 124 based on a format of the retrieved data. For example, the DAG 122 may modify the DAG file 124 based on the retrieved data being a string or a floating point number. The DAG 122 may generate the DAG file 124 based on the stored procedure 126 and the retrieved data. The DAG 122 may generate the DAG file 124 based on the stored procedure 126 such that the DAG file 124 maps between a request from the application server 110 and the stored procedure 126, where the DAG file 124 translates the request into parameters required by the stored procedure 126. In an example, the DAG 122 generates the DAG file 124 based on the stored procedure 126, where the stored procedure 126 is for retrieving aircraft information, and where the stored procedure 126 requires an aircraft identifier as input. In this example, the DAG 122 generates the DAG file 124 to translate a request from the application server 110 for aircraft information into a call to the stored procedure 126, where the call includes the required aircraft identifier. The DAG 122 may generate the DAG file 124 based on the stored procedure 126 and the retrieved data, where the DAG file 124 translates the request into parameters required by the stored procedure 126. The DAG file 122 may generate the DAG file 124 based on a format of the retrieved data. In an example, the DAG 122 generates the DAG file 124 based on the stored procedure 126 and the retrieved data, where the stored procedure 126 is for retrieving aircraft information, and where the stored procedure 126 requires an aircraft identifier as input, and where the retrieved data includes the aircraft information in a string. In this example, the DAG 122 generates the DAG file 124 to translate a request from the application server 110 for an aircraft model into a call to the stored procedure 126, where the call includes the required aircraft identifier and where the DAG file 124 retrieves the aircraft model from the aircraft information in the string returned by the stored procedure 126.

The DAG 122 may automatically generate the DAG file 124 to include object code and calling code to call the stored procedure 126. The DAG file 124 may include object code and calling code to call the stored procedure 126 based on a request from the application server 110. The DAG 122 may generate the DAG file 124 to map between a property in the application and a property in the database such that a request from the application server 110 for data associated with the property in the application returns data associated with the property in the database, where the property in the application is related to the property in the database 128. In an example, the property in the application may be length of ownership of an aircraft and the property in the database may be a date of a purchase of the aircraft. The request from the application server 110 may include a database operation and an identifier of the database 128. The DAG file 124 may include a mapping between the database operation and the stored procedure 126. For example, the database operation may be to retrieve data from the database and the stored procedure may be to return data from one or more tables of the database.

A request for data from the application server 110 to the data server 120 may be in a format and/or programming language different from a format and/or programming language used on the data server 120. The DAG file 124 may include object code and calling code to translate the request from the application server 110 into a format and/or programming language for calling the stored procedure 126. Translating the request from the application server 110 may include generating a second request for calling the stored procedure 126. Calling the stored procedure 126 may include executing the stored procedure 126 to access data in the database 128 according to the stored procedure 126. The DAG file 124 may include access rights for accessing the database 128. The access rights may define which users of the application may access the database 128.

In an example, a user of the application inputs, at the user computer 130, input requesting a database operation at the user interface of the application. The application server 110 transmits a request based on the input to the data server 120. The data server 120 translates the request from the application server 110 into a call to the stored procedure 126 using the DAG file 124. In translating the request using the DAG file 124, the data server 120 verifies that the user has access rights to access the database 128.

The DAG file 124 may be stored on the data server 120. The DAG file 124 may be stored in the database 128. The DAG file 124 may be stored on the administrator computer 140. The DAG file 124 is accessible to the data server 120 such that the data server 120 can use the DAG file 124 to translate a request from the application server 110 into a request for data in the database 128. In some implementations, the DAG 122 is stored on the administrator computer 140. The administrator computer 140 may execute the DAG 122 to generate the DAG file 124. In some implementations, the DAG 122 may generate a plurality of DAG files based on a plurality of stored procedures. The DAG 122 may generate one or more DAG files based on each of the plurality of stored procedures.

The administrator computer 140 may modify the stored procedure 126. The administrator computer 140 may modify the stored procedure 126 to alter what data on the database 128 is accessed using the stored procedure 126. The administrator computer 140 may modify the stored procedure 126 to alter how the stored procedure 126 accesses the data in the database 128. The administrator computer 140 may modify the stored procedure 126 to improve a performance of the database server 120. In this way, the administrator computer 140 may optimize performance of the database server 120. Generating the database access file 124 based on the stored procedure 126 allows the administrator computer 140 to optimize the performance of the database server 120 in translating requests from the application server 110 into requests to access data in the database 128 by calling the stored procedure 126.

The DAG file 124 may be modified, or a new DAG file 124 may be generated based on the modified stored procedure 126. The data server 120 may receive the update to the stored procedure 126 from the administrator computer 140. The data server 120 may receive a notification of the update to the stored procedure 126 from the administrator computer 140. The DAG 122 may receive the update to the stored procedure. The DAG 122 may receive the notification of the updated to the stored procedure. The data server 120 and/or the DAG 122 may periodically poll the administrator computer for updates to the stored procedure 126. The DAG 122 may periodically poll the stored procedure 126 for modifications or updates and in response to the modifications or updates, modify the DAG file 124 or generate a new DAG file 124.

The administrator computer 140 may modify the DAG file 124. The administrator computer 140 may modify the DAG file to modify how the data server 120 translates requests from the application server 110 into requests to access the data in the database 128 using the stored procedure 126. In this way, the DAG 122, by generating the DAG file 124, allows the administrator computer to optimize the performance of the data server 120 by modifying the DAG file 124. The administrator computer 140 may modify the DAG file 124 to modify the data access rights. The administrator computer 140 may modify the data access rights to modify which users are able to access the database 128. In this way, the DAG 122, by generating the DAG file 124, allows the administrator computer 140 to adjust the access rights by modifying the DAG file 124.

The application server 110 may include one or more virtual machines or containers running thereon. The application server 110 may include multiple copies of instances of entities running on the application server 110 which perform the functions of the application server 110 as discussed herein. The application server 110 may include multiple computing and/or storage devices. The application server 110 may be virtualized across multiple clusters of a public and/or private cloud.

The data server 120 may include one or more virtual machines or containers running thereon. The data server 120 may include multiple copies of instances of entities running on the data server 120 which perform the functions of the data server 120 as discussed herein. The data server 120 may include multiple computing and/or storage devices. The data server 120 may be virtualized across multiple clusters of a public and/or private cloud.

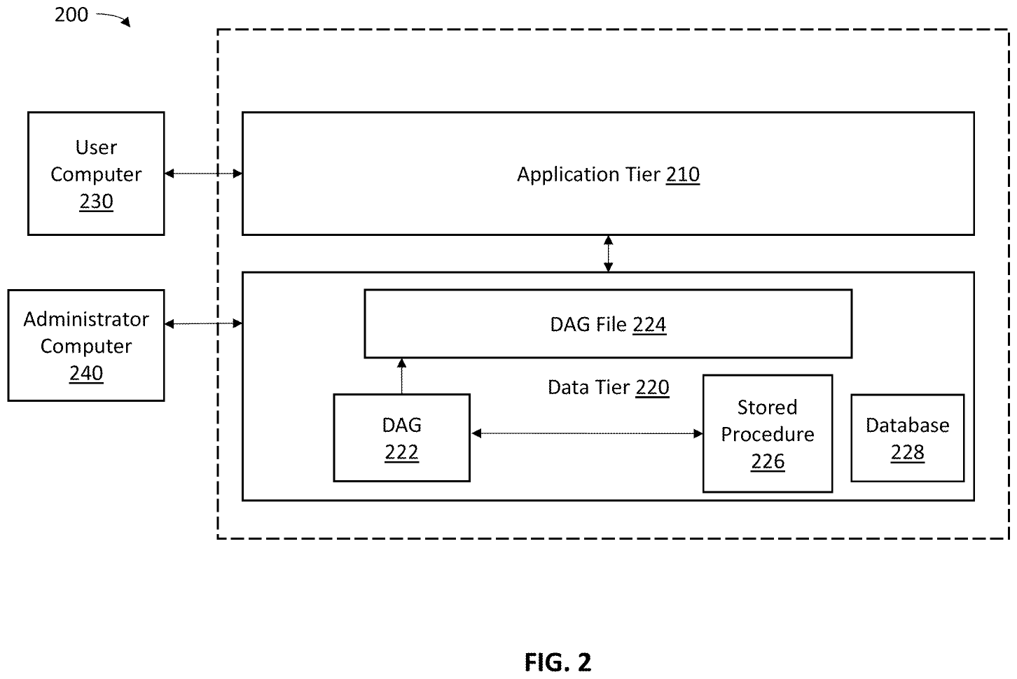

FIG. 2 illustrates another example computer system 200, in accordance with some embodiments of the present disclosure. The computer system 200 includes a computing device 205, a user computer 230, and an administrator computer 240. The computing device 205 includes an application tier 210 and a data tier 220. The application tier 210 may be software running on the computing device which performs the functions of the application tier 110 of FIG. 1. The data tier 220 may be software running on the computing device which performs the functions of the data tier 120 of FIG. 1. The computing device 205 may include one or more processors and one or more non-transitory, computer readable mediums including instructions which may be executed by the one or more processors.

The computer system 200 may include one or more virtual machines or containers running on the computing device 205. The application tier 210 may be a virtual machine or container virtualized using one or more processing resources and/or one or more memory or storage resources of the computing device 205. The data tier 220 may be a virtual machine or container virtualized using one or more processing resources and/or one or more memory or storage resources of the computing device 205.

A DAG file 224 may be similar to the DAG file 124 of FIG. 1. The DAG file 224 may include information specific to the computing device, the application tier 210 and the data tier 220 for translating requests from the application tier 210 into requests to access the database 128 using a stored procedure 126. The stored procedure 126 may be similar to the stored procedure 126 of FIG. 1. In some implementations, the stored procedure 126 may be the same as the stored procedure 126 of FIG. 1.

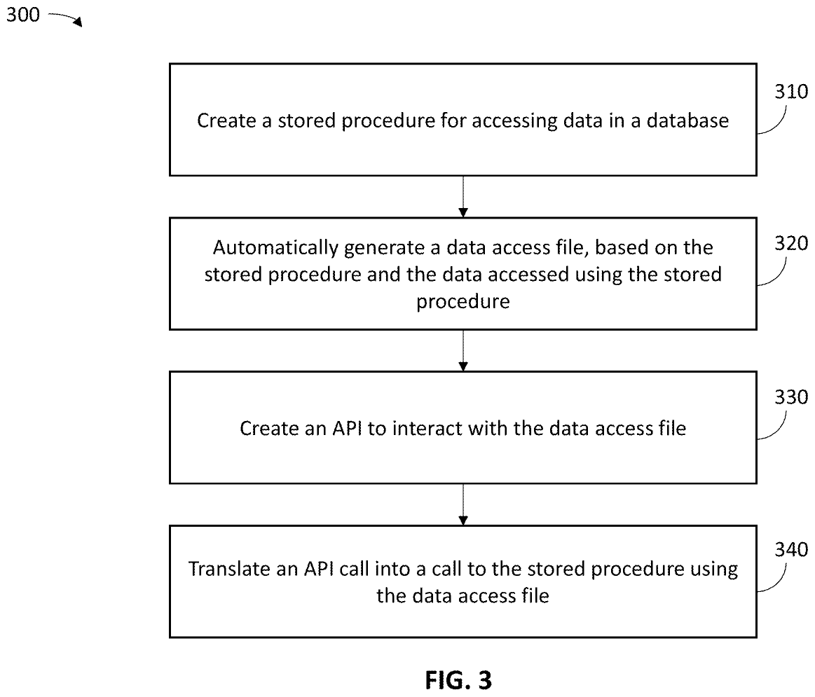

FIG. 3 is an example flow chart illustrating operations of a method 300 for generating data access files, in accordance with some embodiments of the present disclosure. The method 300 may include more, fewer, or different operations than shown. The operations may be performed in the order shown, in a different order, or concurrently. The method 300 may be performed by one or more components of the computer system 100 of FIG. 1 or the computer system 200 of FIG. 2.

At operation 310, a stored procedure is created for accessing data in a database. The stored procedure may be created by an administrator computer. The stored procedure may be created by a data server on which the database is hosted. The stored procedure may be created by a computing device on which the database is hosted. The stored procedure may define a process for accessing data in the database. The database may include one or more tables or views of the database. The stored procedure may return data from the one or more tables or views based on one or more input parameters.

At operation 320, a data access file is automatically generated based on the stored procedure and data accessed using the stored procedure. The data access file may be the DAG file of FIG. 1. The data access file may be generated by a DAG executed on a database tier or an administrator computer. The data access file may facilitate communication between an application tier and a data tier. The DAG may access the stored procedure to determine what inputs the stored procedure requires. The DAG may generate the data access file based on the stored procedure and the inputs required by the stored procedure. The DAG may call the stored procedure to retrieve data from the database. The DAG may modify the data access file based on the retrieved data. The DAG may modify the data access file based on a format of the retrieved data. The DAG may generate the data access file based on the stored procedure and the retrieved data. The DAG may generate the data access file based on the stored procedure such that the data access file maps between a request from the application tier and the stored procedure, where the DAG file translates the request into parameters required by the stored procedure. The data access file may include object code and calling code for translating the request from the application tier into a call to the stored procedure on the data tier.

At operation 330, an API is created to interact with the data access file. The API may be generated by an administrator computer, the data tier, or the application tier. The API may be configured to send requests for database operations from the application tier to the data tier. The API may be created to interact with the data access file. The API may be created to include information associated with input parameters specified in the data access file for calling the stored procedure.

At operation 340, an API call is translated into a call to the stored procedure using the data access file. The application tier may make the API call to the data tier. The application tier may make the API call to the data tier based on user input from a user. The API call may include information associated with the input parameters of the stored procedure. The data access file may include object code for parsing the API and translating information in the API call into information for calling the stored procedure. The data access file may include calling code for using the information for calling the stored procedure to call the stored procedure. In an example, the API call includes a request for information in the database. The object code of the data access file extracts information from the request and translates the information into input parameters of the stored procedure. The object code delivers the input parameters of the stored procedure to the calling code which calls the stored procedure using the input parameters.

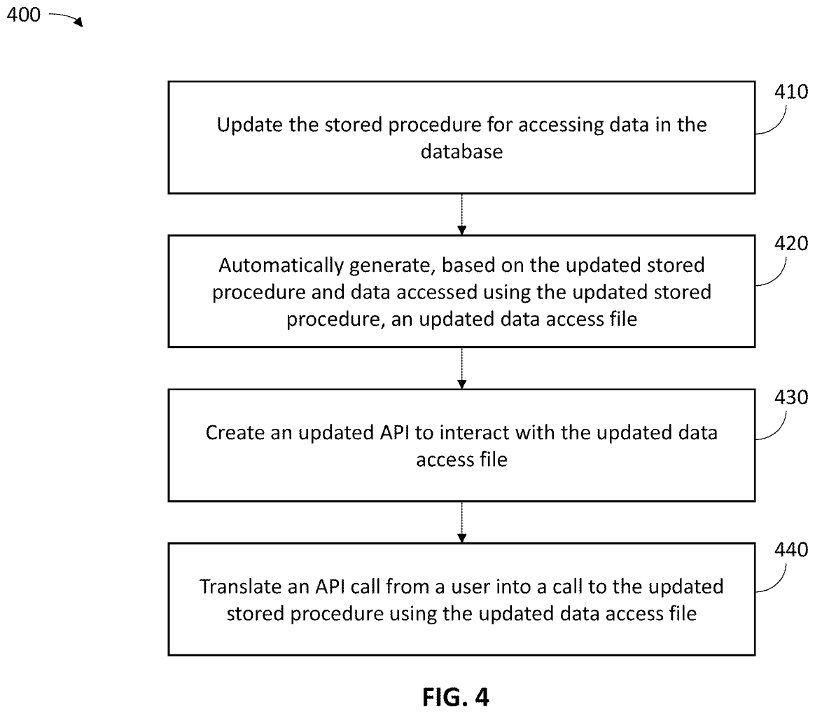

FIG. 4 is an example flow chart illustrating operations of a method 400 for generating updated data access files, in accordance with some embodiments of the present disclosure. The method 400 may include more, fewer, or different operations than shown. The operations may be performed in the order shown, in a different order, or concurrently. The method 400 may be performed by one or more components of the computer system 100 of FIG. 1 or the computer system 200 of FIG. 2. The method 400 may be a continuation of the method 300 of FIG. 3.

At operation 410, the stored procedure for accessing data in the database is updated. The stored procedure may be updated by the administrator computer. The administrator computer may updated the stored procedure to improve performance of the data tier, as discussed herein. The administrator computer may update the stored procedure to modify what data the stored procedure accesses and/or how the stored procedure accesses data in the database.

At operation 420, an updated data access file is generated based on the updated stored procedure and data accessed using the updated stored procedure. The updated data access file may be generated by the administrator computer or the data tier. The updated data access file may be a new data access file or an updated version of the data access file. The updated data access file may be configured to call the updated stored procedure. The updated data access file may include updated object code and updated calling code.

At operation 430, an updated API is created to interact with the updated data access file. The updated API may be created by the administrator computer or the application tier. The updated API may be configured to include information associated with input parameters of the updated stored procedure. The API may be configured to send requests for database operations from the application tier to the data tier.

At operation 440, an API call using the updated API is translated into a call to the updated stored procedure using the updated data access file. The application tier may make the API call to the data tier. The application tier may make the API call to the data tier based on user input from a user. The API call may include information associated with the input parameters of the updated stored procedure. The updated data access file may include the updated object code for parsing the API and translating information in the API call into information for calling the updated stored procedure. The data access file may include the updated calling code for using the information for calling the stored procedure to call the updated stored procedure. In an example, the API call includes a request for information in the database. The updated object code of the updated data access file extracts information from the request and translates the information into input parameters of the updated stored procedure. The object code delivers the input parameters of the stored procedure to the updated calling code which calls the updated stored procedure using the input parameters.

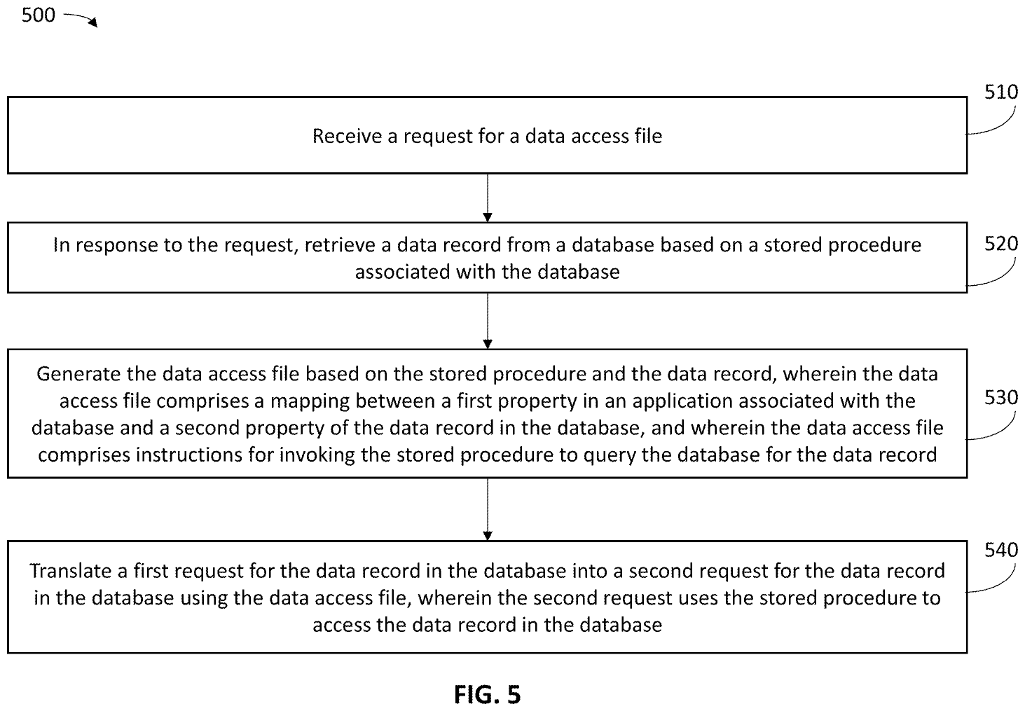

FIG. 5 is an example flow chart illustrating operations of a method 500 for generating, by a server, data access files, in accordance with some embodiments of the present disclosure. The method 500 may include more, fewer, or different operations than shown. The operations may be performed in the order shown, in a different order, or concurrently. The method 500 may be performed by one or more components of the computer system 100 of FIG. 1 or the computer system 200 of FIG. 2, such as the data server 120 of FIG. 1 or the data tier 220 of FIG. 2. As discussed herein, the data server 120 of FIG. 1 may be a data tier of an application.

At operation 510, the data tier receives a request for a data access file. The data tier may receive the request for the data access file from an administrator computer. The programming for generating the data access file configures the data access file to invoke (or “call”) one or more stored procedures (e.g., database queries, database filters or views) in a database, where the stored procedure includes a process for performing a database operation in the database. For instance, the stored procedure includes a preconfigured operation that queries, displays, or otherwise accesses certain data records in the database. In some cases, the request for the data access file includes the actual stored procedure that the data access file will be configured to call. In some cases, the request for the data access file includes data indicating or identifying the stored procedure that the data access file will be configured to call. When generated or configured, the data access file includes executable instructions configured to call the stored procedure to query and retrieve certain data in the database according to a request from an application tier, and/or perform any number of other types of database operations in the database according to the request from the application tier. The data access file may translate between the request from the application tier and the stored procedure to access the data in the database.

At operation 520, the data tier, in response to the request, retrieves a data record from the database based on the stored procedure. The data tier may execute the stored procedure to access the data record which the stored procedure is configured to return. The data tier may determine, using the stored procedure and the returned data, inputs required by the stored procedure. The data tier may determine a mapping between the request from the application tier and the stored procedure. The data tier may determine which information in the request form the application tier corresponds to the inputs required by the stored procedure.

At operation 530, the data tier generates the data access file based on the stored procedure and the data record. The data tier may generate the data access file based on a format of the data record. The data tier may generate the data access file to translate between the request from the application tier and the stored procedure. The data tier may generate the data access file to include object code for parsing the request from the application tier and calling code for calling the stored procedure. The data tier may generate the data access file to translate the request from the application tier into a call to the stored procedure. The data access file may include object code and calling code. The object code of the data access file may include a mapping between a first property in an application associated with the database and a second property of the data record in the database. The application may run on the application tier and the request from the application tier for the data access file may be made by the application. The calling code of the data access file may include instructions for calling or invoking the stored procedure to query the database for the data record.

At operation 540, the data tier translates a first request for the data record in the database into a second request for the data record in the database using the data access file, wherein the second request uses the stored procedure to access the data record in the database. The first request for the data record may be the request from the application tier. The first request may include an identifier of the database. The second request may be a call to the stored procedure. The data tier, using the data access file, may parse the first request to determine information requested by the application tier. The data tier, using the data access file, may map the information requested by the application tier to the stored procedure. The data tier, using the data access file, may determine, based on the first request, inputs for the stored procedure. The data tier, using the data access file, may call the stored procedure using the determined inputs. The call to the stored procedure may be the second request. The data tier may transmit the data record returned by the stored procedure to the application tier. The data tier may respond to the first request using the returned data record. In some implementations, the data tier may use the data access file to translate the returned data into a response to the application tier.

Embodiments may include methods implemented by computing devices or processors. The method comprises receiving, by a processor, a request for a data access file indicating a stored procedure for accessing a database; identifying, by the processor, a data record in the database using the stored procedure, the stored procedure comprising executable instructions for accessing the data record in the database; generating, by the processor, the data access file based on the stored procedure and the retrieved data record, the data access file including a mapping between a first property in an application associated with the database and a second property of the data record in the database, and the data access file further including instructions for invoking the stored procedure to query the database for the data record; and in response to receiving a first request for the data record in the database, translating, by the processor, the first request for the data record into a second request for the data record according to the mapping in the data access file. The second request may use the stored procedure invoked by the data access file to access the data record in the database.

The method may include, in response to an update to the stored procedure, retrieving, by the processor, a second data record from the database based on the updated stored procedure; generating, by the processor, an updated data access file based on the updated stored procedure and the second data record; and translating, by the processor, a third request for the data record in the database into a fourth request for the data record in the database using the updated data access file. The fourth request uses the updated stored procedure to access the second data record in the database.

The method may include receiving, by the processor, an indication of the update to the stored procedure from the database.

The method may include periodically polling, by the processor, the database for the update to the stored procedure.

The update to the stored procedure may made by an administrator computer.

The stored procedure may be configured to return data from one or more tables of the database based on one or more input parameters.

The first request may comprise an application programming interface (API) call.

The second request may use a calling code of the data access file to call the stored procedure.

The first request may comprise a database operation and an identifier of the database.

The data access file may comprise a mapping between the database operation and the stored procedure.

Embodiments may include a system comprising a database and a server. The database comprises a non-transitory machine-readable storage medium configured to store a plurality of data records and query the plurality of data records according to one or more stored procedures. The server comprises a processor, configured to: in response to receiving a request for a data access file indicating a stored procedure for accessing a database, retrieve a data record from the database based on the stored procedure containing instructions for accessing the data record in the database; generate the data access file based on the stored procedure and the retrieved data record, the data access file including a mapping between a first property in an application associated with the database and a second property of the data record in the database, and the data access file further including instructions for invoking the stored procedure to query the database for the data record; and in response to receiving a first request for the data record in the database, translate the first request for the data record into a second request for the data record according to the mapping in the data access file. The second request may use the stored procedure invoked by the data access file to access the data record in the database.

The server may be configured to, in response to an update to the stored procedure, retrieve a second data record from the database based on the updated stored procedure; generate an updated data access file based on the updated stored procedure and the second data record; and translate a third request for the data in the database into a fourth request for the data in the database using the updated data access file. The fourth request may use the updated stored procedure to access the second data record in the database.

The server may be configured to receive an indication of the update to the stored procedure from the database.

The server may be configured to periodically poll the database for the update to the stored procedure.

The server may be configured to receive the update to the stored procedure from an administrator computer.

The stored procedure may be configured to return data from one or more tables of the database based on one or more input parameters.

The first request may comprise an application programming interface (API) call.

The second request may use a calling code of the data access file to call the stored procedure.

The first request may comprise a database operation and an identifier of the database.

The data access file may comprise a mapping between the database operation and the stored procedure.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, function, procedure, subroutine, subprogram, or the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that is accessible by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. “Disk” and “disc,” as used herein, include compact disc (CD), laser disc, optical disc, digital versatile disc (DVD), floppy disk, and Blu-ray disc formats, wherein “disks” reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A processor-implemented method comprising:
receiving, by a processor, a request for a data access file indicating a stored procedure for accessing a database;
identifying, by the processor, a data record in the database using the stored procedure, the stored procedure comprising executable instructions for accessing the data record in the database;
generating, by the processor, the data access file based on the stored procedure and the retrieved data record, the data access file including a mapping between a first property in an application associated with the database and a second property of the data record in the database, and the data access file further including instructions for invoking the stored procedure to query the database for the data record; and
in response to receiving a first request for the data record in the database, translating, by the processor, the first request for the data record into a second request for the data record according to the mapping in the data access file, wherein the second request uses the stored procedure invoked by the data access file to access the data record in the database.

2. The computer-implemented method of claim 1, further comprising:
in response to an update to the stored procedure, retrieving, by the processor, a second data record from the database based on the updated stored procedure;
generating, by the processor, an updated data access file based on the updated stored procedure and the second data record; and
translating, by the processor, a third request for the data record in the database into a fourth request for the data record in the database using the updated data access file, wherein the fourth request uses the updated stored procedure to access the second data record in the database.

3. The computer-implemented method of claim 2, further comprising receiving, by the processor, an indication of the update to the stored procedure from the database.

4. The computer-implemented method of claim 2, further comprising periodically polling, by the processor, the database for the update to the stored procedure.

5. The computer-implemented method of claim 2, wherein the update to the stored procedure is made by an administrator computer.

6. The computer-implemented method of claim 1, wherein the stored procedure is configured to return data from one or more tables of the database based on one or more input parameters.

7. The computer-implemented method of claim 1, wherein the first request comprises an application programming interface (API) call.

8. The computer-implemented method of claim 1, wherein the second request uses a calling code of the data access file to call the stored procedure.

9. The computer-implemented method of claim 1, wherein the first request comprises a database operation and an identifier of the database.

10. The computer-implemented method of claim 9, wherein the data access file comprises a mapping between the database operation and the stored procedure.

11. A system comprising:
a database comprising a non-transitory machine-readable storage medium configured to store a plurality of data records and query the plurality of data records according to one or more stored procedures;
a server comprising a processor, configured to:
in response to receiving a request for a data access file indicating a stored procedure for accessing a database, retrieve a data record from the database based on the stored procedure containing instructions for accessing the data record in the database;
generate the data access file based on the stored procedure and the retrieved data record, the data access file including a mapping between a first property in an application associated with the database and a second property of the data record in the database, and the data access file further including instructions for invoking the stored procedure to query the database for the data record; and
in response to receiving a first request for the data record in the database, translate the first request for the data record into a second request for the data record according to the mapping in the data access file, wherein the second request uses the stored procedure invoked by the data access file to access the data record in the database.

12. The system of claim 11, wherein the server is further configured to:
in response to an update to the stored procedure, retrieve a second data record from the database based on the updated stored procedure;
generate an updated data access file based on the updated stored procedure and the second data record; and
translate a third request for the data in the database into a fourth request for the data in the database using the updated data access file, wherein the fourth request uses the updated stored procedure to access the second data record in the database.

13. The system of claim 12, wherein the server is further configured to receive an indication of the update to the stored procedure from the database.

14. The system of claim 12, wherein the server is further configured to periodically poll the database for the update to the stored procedure.

15. The system of claim 12, wherein the server is further configured to receive the update to the stored procedure from an administrator computer.

16. The system of claim 11, wherein the stored procedure is configured to return data from one or more tables of the database based on one or more input parameters.

17. The system of claim 11, wherein the first request comprises an application programming interface (API) call.

18. The server of claim 11, wherein the second request uses a calling code of the data access file to call the stored procedure.

19. The system of claim 11, wherein the first request comprises a database operation and an identifier of the database.

20. The system of claim 19, wherein the data access file comprises a mapping between the database operation and the stored procedure.
